(19) United States
(12) Patent Application Publication
(10) Pub. No.: US 2007/0028116 A1
(43) Pub. Date: Feb. 1, 2007

(54) Data collation system and method

(75) Inventors: Nicholas Murison, Seattle, WA (US); Adrian Baldwin, Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: HEWLETT-PACKARD DEVELOPMENT COMPANY, L.P., Houston, TX (US)

(21) Appl. No.: 11/484,721

(22) Filed: Jul. 12, 2006

(30) Foreign Application Priority Data
Jul. 13, 2005 (GB) 0514340.9

(51) Int. Cl. H04L 9/00

(52) U.S. Cl. 713/181

(57) ABSTRACT

A data collation system and method is disclosed that utilise a central repository, a collection agent, one or more branch agents and one or more leaf agents. Each of the leaf agents is associated with a respective branch agent and each branch agent is associated with the collection agent. Each leaf agent is associated with a computer system and is arranged to obtain data associated with the respective computer system, secure the data, collate the secured data into a batch and transmit the batch to the leaf agent's associated branch agent. Each branch agent is responsive upon receipt of a batch to verify the batch, collate verified batches in an augmented batch and transmit the augmented batch to the collection agent. The collection agent is responsive upon receipt of an augmented batch to verify the augmented batch and store verified augmented batches in said central repository.

### RELATED APPLICATIONS

This Application is related to the US Patent Application entitled “Verification System and Method” by Nicholas Murison and Adrian Baldwin filed on the same date as this Application with attorney docket number 200501485-2. This related application is assigned to the assignee of the present Application and is incorporated by reference herein.

The present application is based on, and claims priority from, British Application Number 0514340.9, filed Jul. 13, 2005, the disclosure of which is hereby incorporated by reference herein in its entirety.

### FIELD OF THE INVENTION

The present invention relates to a data collation system and method that is particularly applicable for use in providing audit data to multiple customers sharing parts of a distributed infrastructure.

### BACKGROUND OF THE INVENTION

An increasing amount of regulation makes it important that those in charge of an enterprise can monitor and understand that IT systems are being correctly managed and run. This problem is becoming particularly pertinent due to new corporate governance laws and regulations where senior management is being held personally liable for non-compliance (e.g. Sarbanes Oxley).

Infrastructure control and transparency are requirements of corporate governance, and indeed good management practice, and must be addressed. Reliable and clear reporting of the current state of one's infrastructure is therefore becoming a necessity.

Current solutions will often revolve around auditors occasionally sampling a paper trail (even a digital one) and checking for compliance for the few cases they have time to examine.

Unfortunately, IT infrastructures are renowned for their poor transparency. Even those tasked with their day to day maintenance can find it hard to maintain a detailed overview of the entire environment. As dynamic infrastructures, such as utility computing become commonplace, these problems will only be exacerbated.

IT infrastructures are monitored via entries in audit logs generated by the infrastructure's respective computer systems and applications. Audit log entries contain descriptions of noteworthy events, warnings, errors or crashes in relation to system programs, system resource exhaustion, and security events such as successful or failed login attempts, password changes etc. Many of these events are critical for post-mortem analysis after a crash or security breach. The reliance on audit logs makes them the first target of an experienced attacker because the attacker wishes to erase traces of the compromise, to elude detection as well as to keep the method of attack secret so that the security holes exploited will not be detected and addressed.

One method suggested to increase security of audit logs is referred to as a forward integrity scheme, one type of which uses a version of message authentication coding called HMAC and is illustrated in FIG. 1. Such schemes enable the relative ordering of events to be cryptographically asserted.

A message authentication code (MAC) is generated for each audit data 30a-30e on creation. The MAC protects the integrity of the audit log entry based on a secret key. The MAC 20a-20e is derived using a secret key and a MAC function (based on a hash function) 10 and appended to the audit data (20a::30a . . . . 20e::30e). The MAC is typically generated using an HMAC function involving two calls to a hash function 10 on a secret and the audit message to be secured. The secret must be shared with the verifier allowing them to regenerate the MAC with their copy of the audit data 30a-30e and check the MAC values (20a-20e) match the newly computed ones. Any variation will indicate tampering with the audit data.

In order to prevent deletion of log entries and reduce the possibility of the secret used in the MAC being discovered or reverse-engineered, an evolving key is used in the hashing function in forward integrity schemes, as is shown in FIG. 1. Each time the hashing function 10 is used to generate a secret for the MAC 20a-20e for a respective audit data 30a-30e, the key 40 is evolved using a one way (cryptographic) hashing function 90 to produce a new key (50-80) which is then used for the next audit data. Each time the key is evolved, the previous key is erased. The base key 40 is securely retained to allow verification of all information as it can be evolved the appropriate number of iterations to obtain any of the keys used for the sequence. In order to check the integrity of an audit log, the verification process evolves the base key 40 through each key (50-80) in turn and uses the respective keys to generate and verify the MAC for the respective audit data 30a-30e. If, for example, the fourth audit data (30d) was deleted, the verification process would attempt to use its respective key (70) to generate the MAC 20e for the fifth audit data 30e and would identify a miss-match highlighting tampering.

Even if they fourth key 70 and hashing functions 10, 90 were compromised, an attacker would only be able to modify log entries based on subsequent keys and could not modify entries in the past (those evidencing the compromise).

Given the initial key 40 and the hashing functions 10, 90, one can verify that the chain of entries in the log matches the chain of MACs. Because only the current MAC key is stored on the live system, an attacker can only seize control and manipulate future log entries without being noticed; old entries will have had their MACs generated under keys to which the attacker does not have access. Although this technique does not prevent the attacker from falsifying current and future log entries, entries prior to their compromise of the system can be used as forensic evidence in a post-attack investigation

Whilst forward integrity schemes are useful for evidencing integrity of a sequence of events recorded by an audit log, they require the MAC be generated as the audit data is created which means this process must be performed at the source of the event to avoid intermediate tampering prior to assignment of the MAC. As such, forward integrity schemes to date are applicable only in extremely simple IT infrastructures.

Utility computing infrastructures are a relatively recent evolution in computing but are becoming increasingly popular. Utility computing infrastructures aim to be flexible and provide adaptable fabrics that can be rapidly reconfigured to meet changing customer requirements. One example is a collection of standard computer servers interconnected using network switches with utility storage provided via some form of SAN technology. Separation of customers within a utility computing system is usually provided by a combination of router and firewall configurations, along with any additional security capability the network switches may offer, such as VLANs.

In utility computing, resources are leased from a remote provider. An example of IT infrastructures using a utility computing infrastructure is shown in FIG. 2. The remote provider may share resources between multiple customers 110, 120. For example, the first customer 110 may have outsourced operation of a database system 130 whilst the second customer may be leasing processor time for running a complex modeling system 140. However, even though both customers may be provided significantly different services, it is possible that a single system 100 maintained by the remote provider may be running processes for both customers concurrently.

One of the major issues with distributed systems such as those using utility computing, in the context of audit, is determining the order in which events on separate parts of the system occurred. A distributed shared customer environment will contain many untrusted agents with many logs and many customer-specific chains of events. It is likely that a utility computing service provider will not wish for all audit log data to be accessible to its customers. Indeed, at least a proportion of the audit log data may be relevant only to a single customer and confidentiality requirements would prevent this being disclosed to other parties without consent. The more dynamic the infrastructure of a distributed system, the more complex it becomes to determine who has rights to what audit data. In addition, audit log data is not always proportional to the size of the respective infrastructure and as the size of the infrastructure grows, so too does the audit log data but at closer to an exponential rate.

No existing auditing technology is known that works in an adaptive environment. In distributed infrastructures such as in utility computing systems, the infrastructure is constantly flexing and changing, making use of virtualisation and on-demand deployment technology to best meet the customer's computing needs. Because such an infrastructure is more optimised, one can expect much larger data throughput in most areas of the network, with a high number of concurrent connections. A centralised audit system could easily buckle under the masses of events generated in such an environment, due to its bottleneck audit database.

Further complications arise from the desired attribute of virtualised data centers to be shared between multiple customers; each customer runs their own virtual infrastructure alongside other customers on the same physical hardware. Having one audit system per customer would work, but essential information regarding the flexing of the infrastructures would often fall outside the customer-specific audit system.

Providing multiple secure customer views of audit logs in a dynamic, high volume and high concurrency adaptive infrastructure is a challenge which needs to be met to provide sufficient information to allow corporate governance and other similar requirements to be satisfied. The alternative would be to have auditors visit each and every site (which in the case of utility computing may not be permitted or practical) and do the current random sampling of paper trails. Not only is this insufficient for corporate governance requirements, it is also very poor at identifying compromises in systems.

### STATEMENT OF INVENTION

According to an aspect of the invention, there is provided a data collation system including a central repository, a collection agent, one or more branch agents and one or more leaf agents, each of the leaf agents being associated with a respective branch agent and each branch agent being associated with the collection agent, wherein:

each leaf agent is associated with a computer system and is arranged to obtain data associated with the respective computer system, secure the data, collate the secured data into a batch and transmit the batch to the leaf agent's associated branch agent;

each branch agent is responsive upon receipt of a batch to verify the batch, collate verified batches in an augmented batch and transmit the augmented batch to the collection agent;

the collection agent is responsive upon receipt of an augmented batch to verify the augmented batch and store verified augmented batches in said central repository.

### BRIEF DESCRIPTION OF THE DRAWINGS

Embodiments of the present invention will now be described in detail, by way of example only, with reference to the accompanying drawings in which:

FIG. 1 is a schematic diagram illustrating forward chaining using an HMAC hash function in accordance with the prior art but useful for implementing embodiments of the invention;

FIG. 2 is a schematic diagram of a number of distributed networks, each using utility computing, in accordance with the prior art but useful for implementing embodiments of the invention;

FIG. 3 is a schematic diagram of a data collation system according to a first aspect of the present invention;

FIGS. 4 to 6 are schematic diagrams illustrating selected aspects of the data collation system in accordance with embodiments of the invention as shown in FIG. 3 in more detail;

FIG. 7 is a flow diagram of selected aspects of a method according to an embodiment of the present invention;

FIG. 8 is a schematic diagram of an indexing system according to embodiments of the invention and suitable for use with the data collation system of FIGS. 3 to 6;

FIG. 9 is a flow diagram of selected aspects of a method according to embodiments of the invention and used by the indexing system of FIG. 8; and,

FIG. 10 is a schematic diagram of the data collation system according to embodiments of the invention and including the systems of FIGS. 3 and 8.

### DETAILED DESCRIPTION

First of all, general aspects of embodiments of the invention will be described, after which specific embodiments of the invention will be discussed in detail.

In embodiments of the present invention, it is sought to provide a data collation method and system suitable for dealing with high volumes and frequencies of audit data, as well as multiple secure customer views of an infrastructure. Resource usage and data flow can be tuned at the cost of accuracy of event times and vice versa. Embodiments of the present invention seek to provide multiple secure customer audit views over dynamic, high volume and high concurrency adaptive infrastructures. Selected embodiments use an agent-based hierarchy to reduce the load on a central collection point. By extending the forward integrity mechanism to provide multiple chains over a set of events, multiple customer views of the audit log can be provided, even if these views are not mutually exclusive.

Symmetric key cryptography can be used, and by tuning the frequency and size of communicated batches and distributing appropriate numbers of agents, embodiments of the present invention seek to provide a highly efficient and non-obtrusive collection hierarchy.

Embodiments of the present invention could be integrated or interfaced with trust record for deployment on a dynamic virtualised IT infrastructure in order to provide accountability for an assurance record.

Untrusted leaf agents (or leaf agents with limited trust) communicate communicating audit data to more trusted branch agents which can verify that the data has not been tampered with. Encryption of the audit data protects from eavesdropping, among other things, which is important for a shared customer infrastructure

Audit data relevant to a specific customer is not readable by any other customer. If audit data is relevant to more than one specific customer, then it is must only be readable by those customers and not any others. Customers are able to verify that audit data relevant to them has not been altered or falsified. Customers are also able to verify that they can see all audit data relevant to them.

By provision of multiple agents, customers are able to access data on demand, even if portions of the system are busy or have failed.

Embodiments are able to process large volumes of audit data at a fairly high frequency and are able to adapt to dynamically changing environments such as in utility computing.

The agents may be implemented in software, hardware or some combination of the two. In one example implementation, the agents may be Java Tm based agents that can be remotely deployed to a part of an infrastructure via a data communications network. In another example implementation, the agents may be hardware based and deployment includes physical installation at a part of an infrastructure.

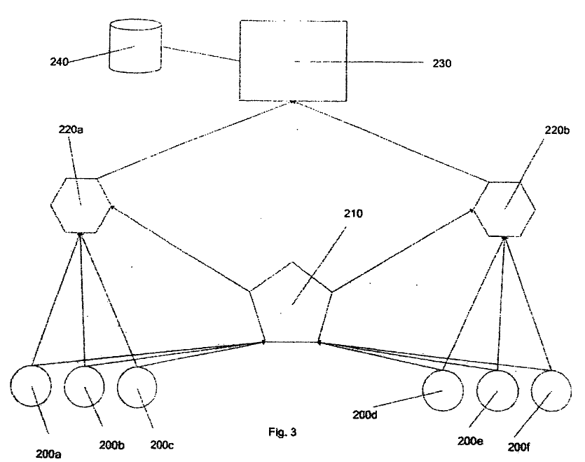

Specific embodiments of the invention will now be described in detail. FIG. 3 is a schematic diagram of a data collation system according to a first aspect of the present invention.

The system includes a number of leaf agents 200a-200f, a secure time stamping agent 210, a number of branch agents 220a-220b and a collection agent 230.

The system has a hierarchical structure with selected branch agents (200a-200c; 200d-200f) reporting to respective ones of the branch agents (220a; 220b), which in turn report to the collection agent 230.

The leaf agents 200a-200f collect audit data from their assigned computer system or computer systems, secure the collected data by obfuscating it and transmit it in batches to their respective branch agent 220a, 220b.

Each branch agent 220a, 200b receives batches from its respective leaf agents (200a-200c; 200d-200f), verifies the authenticity and integrity of the received batches and creates an augmented batch from those batches received and verified within a predetermined time window. The augmented batch for each predetermined time window is transmitted to the collection agent 230. Upon receipt of an augmented batch, the collection agent 230 verifies the authenticity and integrity of the augmented batch and stored verified augmented batches in a central repository 240.

Preferably, each branch agent 220 and collection agent 230 has a dedicated leaf agent 200 for capturing audit data associated with the respective branch or collection agent 230. Data captured at a dedicated leaf agent 200 would work its way into batches submitted to the collection agent 230 in the same manner as other data.

The dedicated leaf agent 200 handles the basic cryptography and securing all the audit events on each machine or system. The dedicated leaf agent 200 may be internal to the respective branch or collection agent or it may be a separate entity or system.

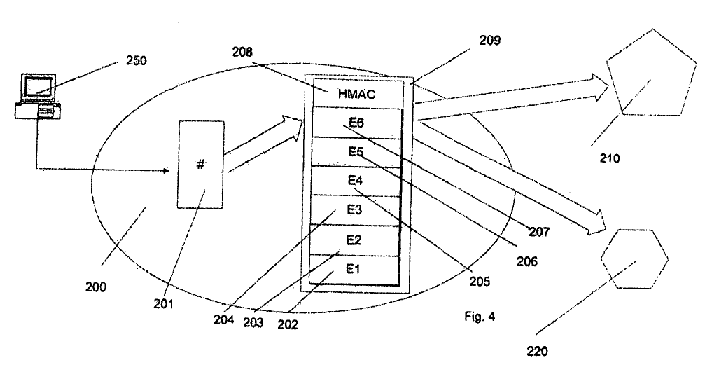

FIG. 4 is a schematic diagram illustrating selected aspects of a leaf agent 200 for use in the data collation system of FIG. 3.

Each leaf agent 200 includes an obfuscation system 201. Audit data is received on events from other components/systems 250 associated with the leaf agent 200 and the origin of the audit data is identified. An event ID is assigned to the audit data in the form:
eventNumber: BatchNumber:LeafAgentid

Audit data received from an associated component or system is passed to the obfuscation system 201 to be secured, where it is obfuscated and added to a batch 209 as obfuscated audit data E1-E6 202-207.

The start and end of a batch 209 is determined by two factors:
1) a predetermined time period assigned to the leaf agent 200 for creating batches; and,
2) a predetermined minimum and maximum number of audit data entries to be assigned to a batch.

For example, a batch 209 could be defined to be an hour long, but it should also contain at least 5 entries and at most 100 entries. This way batch changes are relative to the amount of activity on the agent.

Once a batch 209 is determined to be ended, the leaf agent 200 generates an HMAC 208 for the batch content and adds this to the batch 209.

The batch 209 is then transmitted to the leaf agents associated branch agent 220. A hash of the batch 209 is also transmitted to a time stamping agent 210.

If the communication to either of these two entities 210, 220 fails, audit data is added to the next batch indicating the failure. The old batch content is held in a queue at the leaf agent 200 until communication is successfully restored, at which point re-communication of all queued batches 209 takes place. To avoid batches being filled with entries reporting the failure of communication of prior batches, preferably only audit data is added to a batch when the communication initially fails and another is added when a batch 209 has been successfully communicated.

The time stamping agent 210 receives hashes of batches from leaf agents, time stamps them using a private key, and transmits the time stamp 211 to the branch agent 220 associated with the leaf agent 200. Preferably, the time stamping agent 210 includes a database linking leaf agents to their respective branch agent 220, although other mechanisms can be envisaged. For example, the hash transmitted by the leaf agent to the time stamping agent 210 could include the address or identity of branch agent 220 for delivery.

The time stamping agent 210 uses an independent clock based on accurate time-keeping hardware, enabling customers to verify that events associated with time stamped audit data happened before the time specified by the time stamp. The time stamped data is signed with a PKI based key hence sealing the data batch. Given that the time stamps 211 are computed on batches and represent the window in which events happen, the time stamping agent 210 could cache and order batch events over a time period (say 1 second) and issue a time stamp valid for the batch of events; sending it to all interested branch agents. Such an approach allows for the scaling of time stamp requests within a single site.

Whilst it is useful to ensure each physical or logical site monitored by leaf agents 200 has a local time stamping agent 210, the overall system may rely on multiple time stamping agents 210. In such a situation, synchronization would preferably be performed between time stamping agents 210 through secured Network Time Protocol (NTP).

To protect time stamping agents 210 from denial of service attacks and the like, authentication could be introduced between the leaf agents 200 and the time stamping agent 210. An HMAC of the hash under a leaf agent specific key could be transmitted along with the hash. Unless the HMAC is valid, the time stamping agent 210 will not issue the time stamp 211.

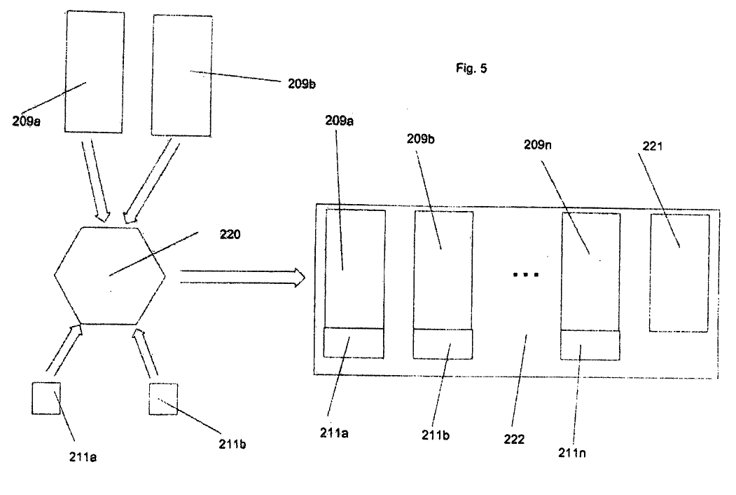

FIG. 5 is a schematic diagram illustrating selected aspects of a branch agent 220 for use in the data collation system of FIG. 3.

Branch agents 220 receive batches 209 from their respective leaf agents 200 and time stamps 211 from the time stamping agent 210.

The branch agent 220 verifies the authenticity and integrity of received batches 209 and time stamps 211 and combines corresponding verified batches 209 and time stamps 211. Each combined batch and time stamp is added to an augmented batch 222. In addition, an identifier for the branch agent 220 is appended to the event IDs in the received batch.

Preferably, the branch agent 220 sends a hash of audit data to its internal leaf agent 200 so as to ensure all the data received from the leaf agents is cryptographically bound into a set of results at the branch agent.

If verification of a batch 209 fails, an audit event is issued to the branch agent's internal leaf agent, and the batch 209 and corresponding time stamp 211 are ignored.

At regular intervals (possibly in a similar manner to the manner described with reference to leaf agents 200 determining when to transmit a batch 209), the branch agent 220 transmits its augmented batch 222 along with a corresponding HMAC 221 to its associated collection agent 230. On failure, audit data is issued to the branch agent's internal leaf agent and retransmission is attempted in the same way as described above with reference to leaf agents 200.

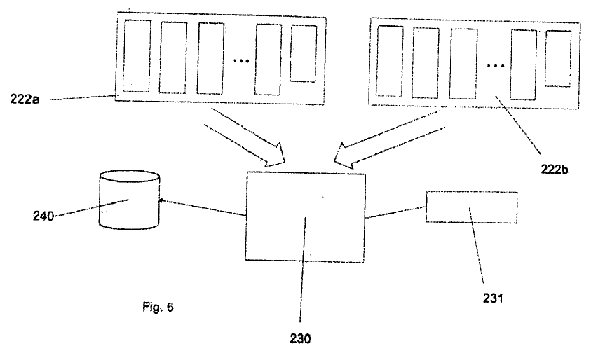

FIG. 6 is a schematic diagram illustrating selected aspects of a collection agent 230 for use in the data collation system of FIG. 3.

The collection agent 230 is responsible for receiving augmented batches 222 from branch agents 220, verifying the HMAC 221 that accompanies them, and adding verified augmented batches 222 to the central repository 240.

Each augmented batch 222 is stored in the central repository 240 with the event ID, allowing it to be retrieved and verified. Preferably, the central repository 240 is a database. The use of a database enables the large amounts of data generated to be managed, replicated and archived using standard database techniques.

If an HMAC verification fails, this is communicated to the branch agent that provided the augmented batch 222 and no changes are made to the central repository 240. Optionally, the collection agent may also log such failures.

In preferred embodiments, a number of collection agents are utilized (preferably one is assigned or otherwise associated with each site, domain or other physical or logical grouping of computer systems), each collection agent 230 being arranged to synchronise its central repository 240 with the other collection agents 230.

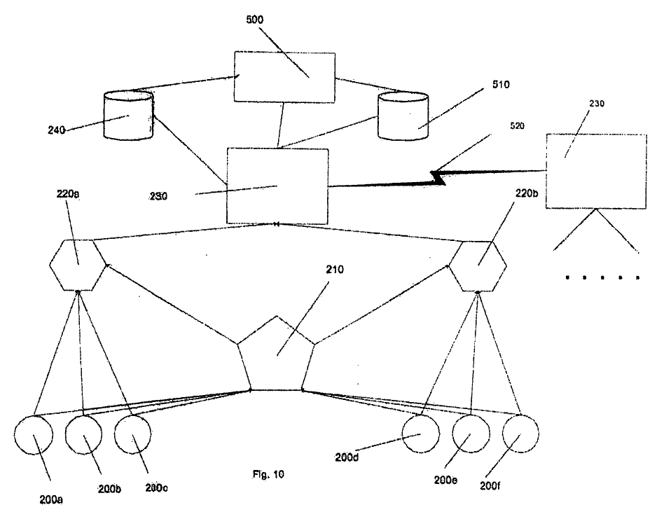

Synchronisation with remote collection agents 230 preferably happens on a peer-to-peer basis, using a peer-to-peer network such as the network 520 illustrated in FIG. 10. Such systems provide a flexible mechanism in case some sites become inaccessible. Changes to the central repository 240 only happen in the form of additions; entries are never removed. Also, additions should never have to overlap, as all batches 209 and augmented batches 222 should be uniquely identifiable (i.e. different leaf agents, event entries etc.).

The obfuscation system 201 used by leaf agents 200 is preferably based on a forward integrity scheme. A master secret is set at the collection agent 230.

Where there are multiple collection agents, a different master secret would be assigned to each collection agent. The master secrets would preferably be generated from a system master secret. Verification of another collection agent's data could be done within the collection agent (by deriving the other collection agent's master secret from the system master secret) or by another trusted system that is deemed sufficiently secure to have access to all the master keys. Verification can be done by a client with the collection agent generating and securely sharing the keys used in securing the individual audit events. The secure time stamp prevents subsequent alteration to data when keys are shared.

Preferably, the master secret and key generation should be carried out within a hardware security appliance or module 231. Such an appliance or module is typically physically secure and includes a processor for cryptography to be performed within the appliance or module such that the master secret never leaves the module or appliance.

Alternatively, the master secret could be protected using a hardware-based Tamper-Proof Module (TPM). In consideration of the long-term storage of the audit entries, it would be wise to regenerate a master secret at regular intervals. A key chain technique such as that described above could be used for such a task.

Each branch agent 220 is assigned a secret by its respective collection agent 230 that is generated in dependence on the master secret. Each leaf agent 200 is assigned a secret by its respective branch agent 220 that is generated in dependence on the branch agent's secret. In this manner, a collection agent 230 can derive any secret used by its associated branch agents 220 or their associated leaf agents 200. Similarly, branch agents can derive secrets used by their associated leaf agents 200. Secrets are derived for use in verifying received batches 209 or augmented batches 222.

The obfuscation system 201 uses a function PRFtype(value). This is a pseudo-random function that given a current value generates a new value; this function needs to be secure so that ideally given the new value an attacker could not derive information about the original value. The type indicates that there may be different PRF functions or different sequence generators for use in different purposes. An example of such a function is a hash function e.g. sha-1. Typically these would be well known and well analysed functions that people trust. It is important that they are one way functions and given the new value very little can be determined about the original value.

The use of the pseudo-random functions (PRFs) to derive secrets means only entities that have access to the initial secrets can derive any of the audit data keys

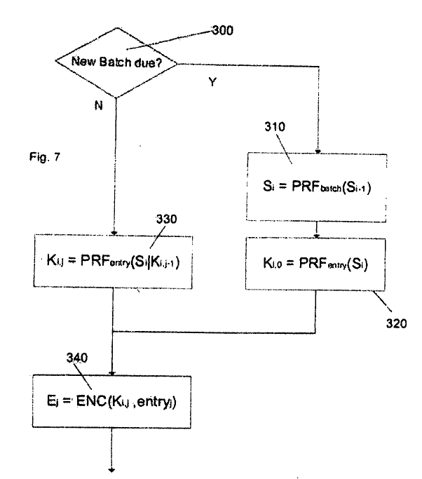

Upon receipt of audit data j, the obfuscation system 201 of a leaf agent 200 operates in accordance with a method illustrated in the flow chart of FIG. 7.

In step 300, it is determined if a new batch is due in accordance with the conditions described above, namely if a predetermined time period has passed and a minimum number of audit data entries have been added to the batch or alternatively if a predetermined maximum number of audit data entries have been added.

If a new batch is due, a new batch is created and in step 310 the batch secret S is incremented by forward integrity using the batch pseudo random function on the previous batch secret.

Using the new batch secret Sᵢ created in step 310, the new audit data key K is derived using the pseudo random function for entries in step 320.

If a new batch is not due, the audit data key K is incremented in step 330 using the previous audit data key and the batch secret S.

The audit data key K derived in step 320 or 330 is then used in step 340 to obfuscate the audit data j (giving Eⱼ) and the obfuscated data Eⱼ is then added to the batch 209.

When each new batch secret S or audit data key K is derived, the previous secret is wiped from memory.

Kᵢⱼ is designed so that individual audit data keys K can be revealed without revealing anything about the next audit data key in the batch. Customers are not allowed to know the batch secret, and thus will not be able to derive the key chain for that batch.

When the batch 209n is deemed complete, the HMAC for the batch 209 is computed using the current batch secret and is added to the batch 209 prior to transmission.

When a branch agent 220 receives a batch from one of its child leaf agents 200, it computes the batch secret using the last batch secret belonging to the leaf agent 200 in question. The branch agent uses the same pseudo random function as is used in step 310. The computed batch secret is used to verify integrity of the received batch 209 by regenerating the HMAC using the batch content and comparing this to the HMAC within the batch 209. In addition, the authenticity of the batch is verified by comparing the identity of the sending leaf agent 200 obtained from a header of the batch 209 with the address or other identifier of the agent from which the branch agent 220 actually received the batch 209.

If either verification fails, an error is communicated to the leaf agent 200 identified as the sender in the batch header, audit data is issued to the branch agent's internal leaf agent, and the received batch 209 is ignored. If the batch 209 is verified, the branch agent 220 checks to see if it has received a time stamp 211 for that batch 209 yet. If not, the batch content is stored in a pre-time stamp queue pending receipt of the time stamp 211. The branch agent may also record the hash of the batch along with the batch identity with its own audit log thus binding events from all its leaf agents into a larger set of events.

When a branch agent 220 receives a time stamp 211 from the time stamping agent 210, it checks whether it has received the relevant batch 209 from the leaf agent 200 yet. If it has not received the batch 209 yet, the time stamp 211 is stored in a pre-batch queue pending receipt of the batch 209 from the leaf agent 200.

The branch agent secret does not need to evolve to ensure forward integrity, but it would be a good idea to not have a long standing secret. The branch agent secret could be evolved periodically at a time agreed with the collection agent or every time one or more augmented batch(es) is/are successfully transmitted.

When a collection agent 230 receives an augmented batch, it verifies the HMAC in the augmented batch by deriving the branch agent's key, recreating the HMAC from the contents of the augmented batch and compares it against the HMAC within the augmented batch. In addition, the authenticity of the augmented batch is verified by comparing the identity of the sending branch agent 220 obtained from a header of the augmented batch with the address or other identifier of the agent from which the collection agent 220 actually received the augmented batch.

Collection agents preferably synchronise their system time using the Network Time Protocol. Security of time synchronisation could be provided through the cryptographic features of NTP version 4. Failures to synchronise logs are recorded as events in the local central repository.

One collection agent is preferably responsible for each geographically separated system segment. It is responsible for maintaining its central repository by collecting event sets from its child agents, synchronising its central repository with those of the other collection agents in the other system segments, and providing inspection functionality for customers to view relevant entries in the central repository.

Collection agents each have a unique secret which is derived from the master secret. In the simplest case, the collection agent secret can be defined as a hash of the master secret and some identity information about the collection agent for which the secret is being generated.

An exemplary system suitable for allowing clients access to the central repository is illustrated below in FIG. 10. Batches of audit data are stored in the central repository 240 and are associated with the batch name and optionally the name of the generating leaf agent 200. Such an arrangement allows event data to be extracted on demand.

In order to access event data, the secrets needed to validate and verify each audit event can be generated. Depending on the desired setup, the secrets can be shared with trusted verification agents or directly shared with a client. The collection agent generates keys which is relatively cheap in computation time and is done in accordance with the event name (branch, leaf agent name, batch name, event number). A client getting a key cannot change an event because it is secured with a time stamp which uses public private key cryptography to secure the whole batch.

A client who has privileges to access a whole batch of data can be given the batch key to allow them to generate the individual event keys themselves.

The various leaf, branch and collection agents could be implemented in hardware, software, firmware or some combination of these. Preferably, agents are implemented using Java to allow agents to be deployed to differing system architectures. The agents could be deployed using a framework such as SmartFrog (a technology developed by HP Labs, and made available on an open source basis through Sourceforge).

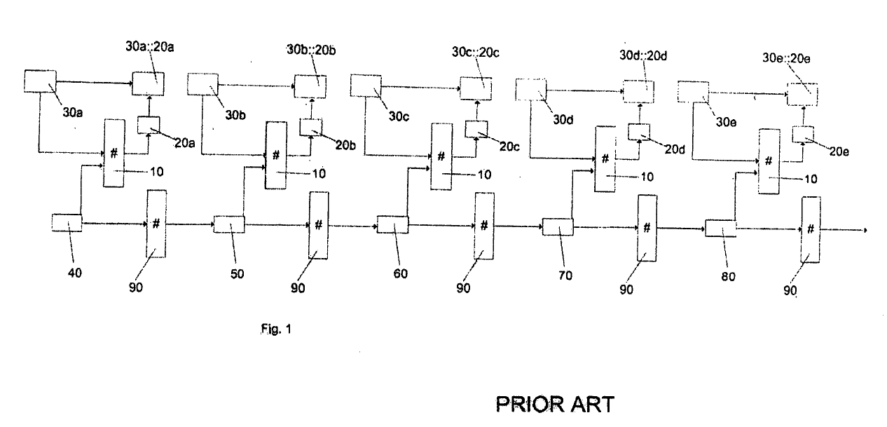

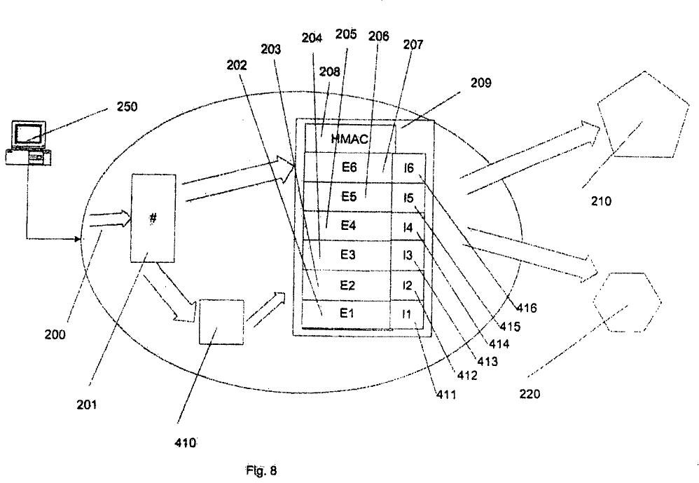

FIG. 8 is a schematic diagram of an audit data indexing system suitable for use with the embodiments of FIGS. 1 to 7.

As discussed above, each leaf agent 200 receives events 400 from other components/systems 250, and identifies their origins.

Each agent 200 includes an index chain lookup table 410. An index chain typically refers to an entity such as a customer or group of customers. The index chain lookup table 410 associates event types and/or origins with one or more index chains.

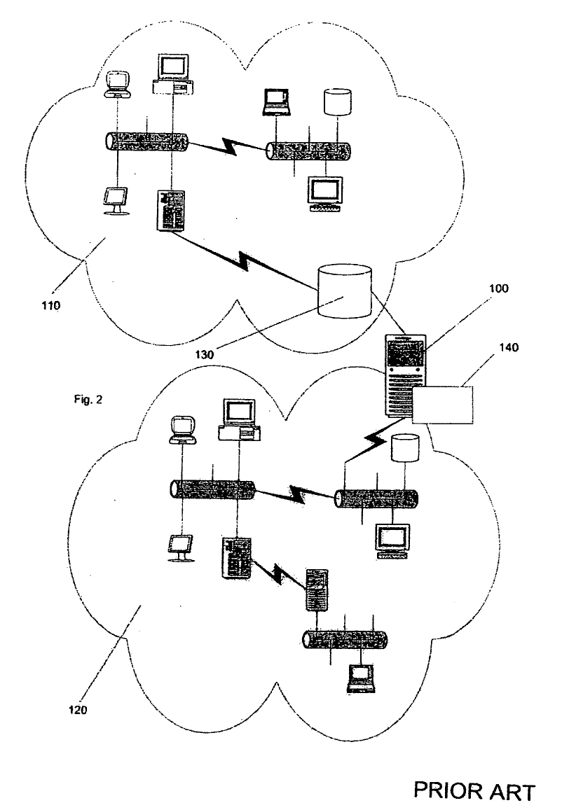

For example, the first customer 110 illustrated in FIG. 2 may be assigned an index chain ‘A’, the second customer 120 index chain ‘B’ and the remote provider index chain ‘C’. Table 1 illustrates example event types and/or origins and the index chains that may be assigned in a sample implementation:

TABLE 1

| Event type | Event Origin | Index |
|---|---|---|
| Database event | Remote provider system 1 | A |
| Modeling system event | Remote provider system 1 | B, C |
| Critical system event | Remote provider system 1 | A, B, C |
| User maintenance event | Remote provider system 1 | C |
| Critical system event | Remote provider system 2 | C |

In the example of Table 1, database events (coming from the outsourced database system 130) are associated with the index chain associated with the first customer, modeling system events (coming from the modeling system 140) are associated with the index chain associated with the second customer and the remote provider and critical system events for the remote provider system 1 are associated with the index chains associated with the first and second customers and the remote provider. User maintenance events and critical system events for remote provider system 2 are associated with the index chain for the remote provider only.

Association of index chains with events identifies the audit data the respective customer or provider is entitled or able to access and verify. In the above example, the remote provider may have decided that the first and second customers did not need to see audit data on user maintenance or on the system 2 (which perhaps may not be providing services to those customers). Similarly, neither customer would want the other to see event data about their hosted systems. The remote provider may have decided it has no need to see audit data associated with the hosted database system or its agreement with the first customer could have prohibited such access.

The lookup table 410 is preferably loaded onto the leaf agent 200 at deployment time, and it should also be possible for alterations to be made by authorised entities during the lifetime of the system (e.g. changes will be made on re-provisioning of an agent). The table is a likely point of attack, and thus must be secured. The issuing authority preferably signs and encrypts the table, ensuring integrity of the data and providing the additional benefit of confidentiality for clients.

Upon receipt of audit data 400, the leaf agent 200 cross-references the data and its origin with its lookup table 410 to identify index chains to be used to tag to the audit data when it has been obfuscated by the obfuscation system 210.

The labeling of index chains as A, B and C above is actually a simplification as it is an index from the respective index chain I1-I6 that is tagged to an obfuscated audit data item E1-E6 (202-207). The index is unique and is derived using a forward integrity scheme such as discussed above. Obfuscated audit data E1-E6 (202-207) may in fact be tagged with an index from more than one index chain. In this situation, only one entry is made in the batch 209 for each obfuscated audit data item E1-E6 but the obfuscated audit data may be appended by multiple indices allowing multiple entities to access and verify the obfuscated audit data.

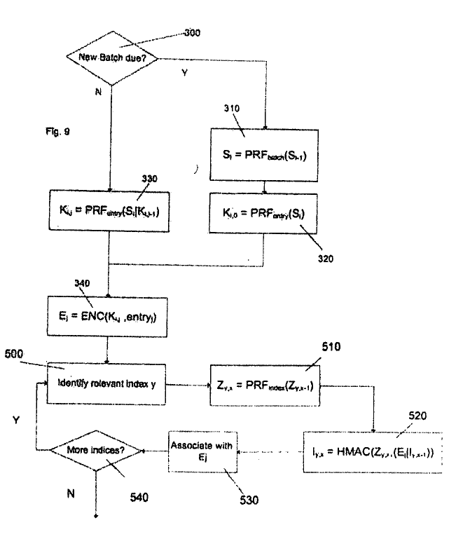

Each new index is generated using a newly evolved key for its respective index chain. FIG. 9 corresponds to the flow diagram of FIG. 7 but includes the additional steps for identifying relevant index chains, generating an index and tagging the index (or indices where there is more than one relevant index chain) to the obfuscated data.

In step 500, a relevant index chain (y) is identified for the audit data using the lookup table 410. In order to operate the forward integrity scheme, a current increment counter x is maintained for each index chain.

In step 510, the increment counter x is incremented and an index key Z_{yx} for the index chain is created using a pseudo-random function for that index chain and the previous value of the increment counter.

In step 520, the unique index I_{y,x} for the obfuscated audit data Eⱼ is calculated in dependence on the index key Z_{y,x}, the value of the obfuscated audit data Eⱼ and the previous unique index I_{y,x-1}.

The unique index I_{y,x} is associated with the obfuscated audit data Eⱼ in step 530 and if it is determined there are more relevant index chains in step 540 then steps 500-530 are repeated for each index chain y.

I_{y,x} is designed to provide a forward integrity chain which is verifiable by authorised parties, i.e. customers with access to the specified index chain, without providing information about the event data. In this way, an authorised customer can verify that a given audit datum is valid without knowing the key used to encrypt the audit data. An index chain can therefore be verified as complete even though the person verifying the index chain may not have access rights to all events. A hash of the audit data could be used instead of the encrypted audit data. However, as the encrypted audit data has to be calculated anyway, we can save some processing time by reusing it.

Z₀ is preferably PRF(AllndexName), where A is the Leaf Agent's secret.

Index chain names should be globally unique across an entire system.

A leaf agent may have to create a new index chain name to label events coming from a newly provisioned resource (i.e. an origin not yet defined in the lookup table 410). In this situation, the new index chain name must either be communicated to its parent branch agent, or be easy for parent agents to deduce based on information about the resource (owning customer, characteristics, etc.). Generating the index chain name and an initial secret may involve the branch/collection agent infrastructure.

The branch agent preferably also maintains an index chain structure storing the index data received from each of the leaf agents that it is associated with. This is done by generating audit data for each index chain (x) included in a received batch containing the last value of Ix,y and this is sent to the branch agent's internal leaf agent thus creating an orderedindex chain of when each branch agent saw a reference to an event within an index chain. This helps create a windowed global ordering within each index chain.

FIG. 10 is a schematic diagram of a data collation system including the systems of FIGS. 3 and 8.

A customer accesses relevant events in the central repository 240 through a portal 500. The portal 500 may be a stand-alone client or may be part of a larger system that allows auxiliary processing of event data, such as event correlation (an example of such a system is described in the applicant's co-pending application, applicant's reference 200500373, the content of which is incorporated by reference). The portal 500 only accesses a locally assigned central repository 240, meaning some recent events from other system sites may not be available. After authenticating the customer, the portal 500 acquires relevant credentials to access events with indexes relevant to the customer from the collection agent 230. Using these credentials, the portal 500 can query the central repository 240.

Verification of index chains can either be done by the customer, or by the portal. In most cases, the portal 500 should be considered a trusted entity, and the customer can leave all validation and correlation processing to the portal 500. However, this assumes a secure channel between the customer. and the portal.

The portal 500 has read-only access to the central repository 240. Any audit-worthy events detected by the portal 500 (e.g. invalid authentication attempts) are logged through a leaf agent 510, either under a customer-specific index or a system-wide index.

To access audit indexes relevant to a customer, the customer must receive the appropriate credentials after authenticating with the system. A customer's credentials are essentially a list of index chains the customer is allowed to query in the central repository 240.

When a customer requests access to a specific index, the portal 500 checks that the customer has the right credentials. On success, the customer is granted access and given the appropriate initial index secret to enable verification of the index chain. On failure, the customer is informed and audit data is issued to the portal's internal leaf agent.

Synchronisation of the central repository 240 with that of other collection agents 230 occurs across the peer-to-peer network 520, although other synchronization systems could easily be used instead of peer-to-peer systems.

The mechanism for resolving which indexes a customer should have access to depends on the customer relationship to the system environment. The portal 500 has access to a lookup table 510 which is generated and updated as the indexes are generated, and system admin functions are undertaken. In a virtualised utility environment, for example, when a new agent is provisioned for a customer, the index chain(s) associated with the provisioning and execution events of that agent should be mapped to that customer in the lookup table 510 in the same manner as they are in the lookup tables of leaf agents 200.

With the initial index secret, the customer can only verify that entries are valid, but not read the actual entries. For this, the customer needs the individual audit data keys, which it can request from the portal 500. Audit data keys are generated from the master secrets (or cached copies of already generated audit data keys). The generation algorithm follows from the audit event name/index name. (i.e. the structure of the keys within the audit system). If the audit data requested is associated with an appropriate index chain for which the customer has gained credentials for, the audit data key is generated

The customer could be given individual keys as requested or keys that allow a whole, or part of a, sequence to be generated. Preferably, the system is arranged to release keys only once they are no longer being used by their respective agent.

Preferably, the customer is able to request audit data keys in bulk, i.e. for an entire index chain. This will be quite computationally intensive for the portal 500, as it will have to generate each audit data key from their individual batch secrets, which again have to be generated from their parent secret, and so on. This is one of the major arguments for using symmetric key cryptography for as much of the key generation process as possible.

The infrastructure, as it is described above, uses symmetric cryptography throughout. As such, key management is based on key chains, where child secrets are derived from parent secrets in a predictable yet secure manner. This does mean that if a secret is leaked, any secrets derived from that secret are implicitly leaked as well. Secrets are contained within a secure environment, higher level agents being more secure and trusted the lower level agents such that if a leaf agent is compromised, only a small proportion of data would be suspect as opposed to much larger amounts if a branch or collection agent is compromised. Security will therefore be provisioned accordingly.

Although the system of FIGS. 8 to 10 has been illustrated implemented using the system of FIGS. 3 to 7, it will be appreciated that other architectures could be used depending on the infrastructure to be monitored, resources available and nature of audit data to be captured. For example, multiple agents may capture data directly, store it locally and synchronise this at a peer-to-peer level without any hierarchical reporting structure.

During preliminary testing 25000 log entries of approximately 80 characters in length spread over 10 leaf agents in the space of 37 seconds were processed using a single desktop PC (2.8 GHz). Roughly half the processing time is taken by the branch agent for verification, and therefore a throughput of approximately 1350 event entries per second is achieved distributed over the 10 leaf agents. Given that 10 leaf agents were run in parallel on one PC, significantly improved results can be expected when agents are deployed to separate systems. These timing results are based on an implementation within java and careful optimisation should be able to increase throughput.

The applicability of the audit service within a large data centre depends on the ability to minimise the impact of securing the audit data within the leaf agent 200 as well as the ability of the overall audit system to cope with the volume of data.

Within the leaf agent 200 there are two significant operations, firstly encrypting and chaining events into the batches with the second being transmitting the batches to a branch agent. Each event requires a hash operation (for the PRF), an encryption of the message and 2 hash operations on the message per index and a further hash operation for the index PRF. As the message increases in size additional blocks must be encrypted and iterations of the hash function must be computed. As such if the average message length is l blocks which fits into i indexes and the secrets have a length of s blocks this means computing l encrypts and (l*2*i)+(1+i)*s basic hash iterations. Assuming both operations are roughly equal this is linear with respect to the message length and the number of indexes per event. From the prototype it is estimated that each event takes 0.00075 seconds to process. The number of bytes sent over the network will largely depend on the message length with additional bytes necessary for the index chaining. Each index chain represents a single block hence roughly n*(l+i) blocks are transmitted to the branch agent 220 where n is the size of the batch.

A busy system may generate roughly 10 events a second with an batch size of 100 would take up 0.0075 seconds cpu per second to secure the data. Assuming each event is 80 bytes it would transmit batches of 10 k every 10 seconds. Whilst the leaf agent 200 should be capable of dealing with this or greater peak throughput, a much lower average throughput. In practice bigger less frequent batches are advantageous and the parameters for creation of a new batch should be selected accordingly.

Verification of a batch requires much the same computational effort as generating the data in the first place. As such a branch agent 220 with a fan out of x leaf agents 200 will need to receive x*n*(l+i) and process l*x encrypts per second and ((l*2*i)+(1+i)*s)*x basic hash operations per second. This is linear with both the average message size, number of indexes per event and the number of leaf agents per branch agent. Assuming the 10 events per second was typical and having a fan out of 100 leaf agents 200 per branch agent 220 then a branch agent 220 would require about 0.75 seconds to validate a second of data. Timeliness is not critical here and so peak loads can be buffered.

Because the timing and size boundaries of batches can be adjusted, the system can be tuned to best accommodate its environment. For example, if the reporting needs to be as real-time as possible, one could define batches to roll over every 5 seconds and only need a minimum of 1 event. This will cause a considerably larger processing and communication load than in an environment where there is less of a demand for immediate event correlation. In such an environment it may be more suitable to have batches roll over every hour, with a minimum of 10 events and a maximum of 500.

The collection agent 230 will receive all generated and batched audit data and must then store it with much of its processing time is associated with data storage within the central repository 240. Given a large busy data centre, say 1000 branch agents 220, each managing 100 leaf agents 200, each generating 1 k per second (based on a 10 k batch per 10 seconds) this would amount to 1 mb per second involving storing 10000 batches per second. This is obviously a large volume of data from a very large 100000 agent data centre and the collection agent 230 would need to rely on a scalable database. However the system is tunable both in terms of the frequency and size of batches that are sent out and the volume of data collected within the audit system. These factors can both be tuned to reduce the data volumes and number of database writes to a manageable amount. Alternatively such a large data centre could use several collection agents 230.

Embodiments are possible that use asymmetric cryptography or Identity Based Encryption for key management.

It will be appreciated that both hash functions and encryption functions are possible for use by the pseudo-random functions used by the obfuscation system discussed.

1. A data collation system including a central repository, a collection agent, one or more branch agents and one or more leaf agents, each of the leaf agents being associated with a respective branch agent and each branch agent being associated with the collection agent, wherein:
each leaf agent is associated with a computer system and is arranged to obtain data associated with the respective computer system, secure the data, collate the secured data into a batch and transmit the batch to the leaf agent's associated branch agent;
each branch agent is responsive upon receipt of a batch to verify the. batch, collate verified batches in an augmented batch and transmit the augmented batch to the collection agent;
the collection agent is responsive upon receipt of an augmented batch to verify the augmented batch and store verified augmented batches in said central repository.

2. A data collation system as claimed in claim 1, wherein the data obtained associated with the respective computer system is data on audit events at or associated with the computer system.

3. A data collation system as claimed in claim 1, wherein the leaf agent includes an obfuscation system for securing the data, the obfuscation system being arranged to obfuscate the data collated into the batch.

4. A data collation system as claimed in claim 1, wherein each leaf and branch agent is arranged to add a message authentication code to their batch or augmented batch, respectively, the message authentication code including a cryptographic hash of the contents of the batch or augmented batch.

5. A data collation system as claimed in claim 4, wherein verification of a batch or an augmented batch includes recreating the message authentication code from the contents of the batch or augmented batch and comparing the recreated message authentication code with the message authentication code in the batch.

6. A data collation system as claimed in claim 1, further comprising a time stamping agent, wherein:
each leaf agent is arranged to transmit data on a collated batch to the time stamping agent;
the time stamping agent is responsive upon receipt of data on a batch to issue a time stamp to the leaf agent's associated branch agent; and, each branch agent is arranged to match and add time stamps to received batches and only to collate batches having matching time stamps.

7. A data collation system as claimed in claim 3, wherein the obfuscation system is arranged to obfuscate the data in dependence on a cryptographic secret obtained from a chain of cryptographic secrets, the cryptographic secret obtained being sequentially evolved along the chain for each obfuscation.

8. A data collation system as claimed in claim 7, wherein the collection agent and the branch agent associated with a respective leaf agent includes data enabling each cryptographic secret from the chain of cryptographic secrets used by the respective leaf agent to be obtained for de-obfuscating the data in the batch.

9. A data collation system as claimed in claim 1, including a plurality of collection agents connected via a peer-to-peer network, each collection agent being uniquely associated with one or more branch agents and each branch agent being uniquely associated with one or more leaf agents, the plurality of collection agents being arranged to synchronise data stored in their respective central repository over the peer-to-peer network.

10. A method of collating data at a central repository database, the method comprising:
associating a collection agent with one or more branch agents and one or more leaf agents with each respective branch agent;
associating each leaf agent with a computer system and arranging the leaf agent to obtain data associated with the respective computer system, secure the data, collate the secured data into a batch and transmit the batch to the leaf agent's associated branch agent;
upon receipt of a batch at a branch agent, verifying the batch, collating verified batches in an augmented batch and transmitting the augmented batch to the collection agent;
upon receipt of an augmented batch at the collection agent, verifying the augmented batch and storing verified augmented batches in said central repository database.

11. A method of collating data as claimed in claim 10, wherein the data obtained associated with the respective computer system is data on audit events at or associated with the computer system.

12. A method of collating data as claimed in claim 10, wherein the step of securing the data includes obfuscating the data.

13. A method of collating data as claimed in claim 10, further comprising the step of adding a message authentication code to each batch or augmented batch, the message authentication code including a cryptographic hash of the contents of the batch or augmented batch.

14. A method as claimed in claim 13, wherein the step of verifying a batch or of verifying an augmented batch includes the steps of:
recreating the message authentication code from the contents of the batch or augmented batch; and,
comparing the recreated message authentication code with the message authentication code in the batch.

15. A method as claimed in claim 10, further comprising:
transmitting data on a collated batch from a leaf agent to a time stamping agent;
receiving data on a batch at the time stamping agent and issuing a time stamp to the leaf agent's associated branch agent; and,
matching and adding time stamps to received batches at the branch agent and only to collating batches having matching time stamps.

16. A method of collating data as claimed in claim 12, wherein the step of obfuscating includes the step of obfuscating data in dependence on a cryptographic secret obtained from a chain of cryptographic secrets, the cryptographic secret obtained being sequentially evolved along the chain for each obfuscation.

17. A method of collating data as claimed in claim 16, wherein the collection agent and the branch agent associated with a respective leaf agent include data enabling each cryptographic secret from the chain of cryptographic secrets used by the respective leaf agent to be obtained for de-obfuscating the data in the batch.

18. A method of collating data as claimed in claim 10, further comprising the steps of:
interconnecting a plurality of collection agents via a peer-to-peer network;
uniquely associating each collection agent with one or more branch agents;
uniquely associating each branch agent with one or more leaf agents; and,
synchronising data stored by the plurality of collection agents over the peer-to-peer network.

19. A computer readable medium having computer readable code means embodied therein for collating data in a central repository database and comprising:
computer readable code means for associating a collection agent with one or more branch agents and one or more leaf agents with each respective branch agent;
computer readable code means for associating each leaf agent with a computer system and arranging the leaf agent to obtain data associated with the respective computer system, secure the data, collate the secured data into a batch and transmit the batch to the leaf agent's associated branch agent;
computer readable code means for operating a branch agent to, upon receipt of a batch, verify the batch, collate verified batches in an augmented batch and transmit the augmented batch to the collection agent;
computer readable code means for operating a collection agent to, upon receipt of an augmented batch, verify the augmented batch and store verified augmented batches in said central repository database.

20. A computer readable medium as claimed in claim 19, wherein the computer readable code means for securing the data includes computer readable code means for obfuscating the data in dependence on a cryptographic secret obtained from a chain of cryptographic secrets, the cryptographic secret obtained being sequentially evolved along the chain for each obfuscation.
